(19) United States
(12) Patent Application Publication
(10) Pub. No.: US 2005/0118916 A1
(43) Pub. Date: Jun. 2, 2005

(54) Composite absorbent structures with nonwoven substrates with improved lamination integrity

(75) Inventors: Paul M. Ducker, St. Simons, GA (US); Krishnakumar Rangachari, Savannah, GA (US)

Correspondence Address: WOOD, PHILLIPS, KATZ, CLARK & MORTIMER, 500 W. MADISON STREET, SUITE 3800, CHICAGO, IL, 60661, US

(73) Assignee: Rayonier Products And Financial Services Company.

(21) Appl. No.: 10/969,596

(22) Filed: Oct. 20, 2004

Related U.S. Application Data
(60) Provisional application No. 60/512,944, filed on Oct. 21, 2003.

(51) Int. Cl. B32B 23/10

(52) U.S. Cl. 442/385; 156/62.2; 156/209

(57) ABSTRACT

In accordance with the present invention, a composite absorbent structure is formed by air laying an absorbent core comprising cellulosic fibers, typically wood pulp fibers. The absorbent core may include superabsorbent polymeric material (SAP), for enhanced liquid absorption and retention. The present invention contemplates that a nonwoven fabric layer be provided which comprises polymeric fibrous material, either in staple length or filamentary form. A composite material is formed in which the cellulosic fibers are hydrogen bonded to form an absorbent core and the nonwoven fabric layer is laminated to this hydrogen bonded layer, without adding additional non-cellulosic bonding agents (the cellulosic fibers themselves act as their own bonding agents) either to the cellulosic layer or between the cellulosic layer and the nonwoven.

### TECHNICAL FIELD

The present invention relates generally to formation of disposable absorbent structures, and more particularly to a composite absorbent structure comprising a hydrogen bonded air laid absorbent core including cellulosic fibers, and an associated nonwoven fabric layer comprising polymeric fibrous material, with formation effected without adding any non-cellulosic bonding material to the hydrogen bonded airlaid portion of the core or between that and the nonwoven. This may be calender bonded using a heated calender.

### BACKGROUND OF THE INVENTION

Disposable absorbent structures are employed in a wide variety of applications, including disposable absorbent apparel, such as diapers and incontinence products, sanitary products, wound dressings, food packaging (such as for meats), and the like. Heretofore, disposable absorbent structures have typically included cellulosic fibrous material, such as wood pulp or cotton linters, with the optional inclusion of superabsorbent polymers (SAP) enhancing liquid absorption and retention. A very economical method of bonding this sheet is to use hydrogen bonding, as taught by U.S. Pat. No. 5,866,242 and No. 5,916,670, since no other materials are required to form the bonds. These hydrogen bonded airlaid composites usually comprise a carrier layer of tissue, cellulosic fibers airlaid onto this tissue carrier, and optionally, an additional tissue bonded to the top surface, all of which are bonded with a heated calender.

The use of nonwoven fabric structures, which may typically comprise polymeric fibrous or filamentary material, is also common for the formation of disposable absorbent structures. Such nonwoven fabrics may provide facing or backing layers for use in association with an absorbent core, and may be integrated with the core to enhance structural integrity and/or facilitate liquid absorption, distribution, and retention. Nonwoven fabric structures can be formed in a wide variety of fashions, including thermal point bonding of spunbond structures, thermal through-air bonding of staple fiber structures, and resin bonding. These technologies are well established and commercialized.

Experience has shown that there are many applications which require attachment of a nonwoven fabric substrate to an associated air laid fibrous core to thereby provide additional strength and integrity for the composite structure. In a calender bonded airlaid operation, it would be very convenient and cost-effective to have a nonwoven substrate as a drop-in replacement for one or more of the layers of tissue currently used in the hydrogen bonded composite. Heretofore, problems have been encountered achieving sufficient adhesion between the typical cellulosic fiber of the hydrogen bonded air laid core, and the synthetic fibers of the nonwoven fabric, without resorting to the use of an added bonding agent to the air laid structure or between the air laid layer and nonwoven layer.

One alternative involves introducing an adhesive layer between the nonwoven and the air laid cellulosic layer. The problem with this is that the adhesives add cost to the system, and the equipment required to apply it is often very capital intensive, complex and introduces some level of additional downtime into what is otherwise a very reliable process.

Another alternative is to abandon the use of a hydrogen bonded airlaid system and instead use traditional bonded airlaid material, in which bonding materials are added to the cellulosic fibers, apply a nonwoven substrate, and then bond the web in a through-air oven, which is a method well known in the art for activating these adhesive materials. One bonding material well known in the art is bi-component PE/PET or PE/PP fibers, whereby the heat from an oven melts low melting point sheath of polyethylene on the fibers, creating interfiber adhesion as well as lamination adhesion between the air laid portion of the sheet and the nonwoven substrate. Another variant of this would be to use powder adhesives. Another technology well known in the art is to apply a water-based latex bonder, and again, pass the web with the nonwoven substrate through an oven to drive off the moisture and cure the latex resin, creating adhesion between the fibers in the air laid sheet, as well as lamination adhesion between the air laid portion of the sheet and the nonwoven substrate. In each case, the specialized adhesive materials add cost to the system. Additionally, the adhesive materials are relatively non-absorbent, and they also tend to reduce the absorbent potential of the cellulosic fibers and SAP in the system by restraining the sheet from expanding and preventing full absorption. The through-air ovens typically used on air laid machines for these applications limit the machine speed, are very capital and energy-intensive, and also tend to introduce contamination into the sheet when charred materials coating the inside surfaces of the oven become loosened and fall into the sheet.

Hydrogen bonded airlaid materials have advantages over the traditional latex bonded or bi-component fiber bonded airlaid materials in their simplicity. All of the material in the sheet is absorbent. Additional advantages are found in the calender bonding process used to make hydrogen bonded airlaid materials. Compared to air laid process involving through-air bonding ovens, calenders are less complex, potentially faster, and require much less capital. Calender bonded air laid sheets, however, do not have the tensile strength that typical latex bonded or multi bonded airlaid sheets do which contain bonding agents, adhesives, or high-strength fibers. A need is then to find a way to incorporate a nonwoven substrate into a calender bonded sheet, increasing the tensile strength, and achieve useful lamination strength between airlaid and nonwoven components without incurring the cost of adding adhesive materials such as hot melt glues, etc or requiring that additional processes other than the existing calender be used to form this effective lamination bond. This would allow materials to be produced with superior strength and a wider range of properties while utilizing the existing capital assets on calender bonded airlaid equipment. It also avoids the cost of adding non-absorbent adhesive materials to the hydrogen bonded airlaid sheet, which may interfere with the absorption of the sheet. Since synthetic nonwovens do not typically create hydrogen bonds, and would be required to melt in a calender bonded process in order to form bonds to the cellulosic composite, it previously seemed obvious that any attempt to calender bond a synthetic nonwoven in direct contact with a heated calender would result in a portion of the nonwoven melting and adhering to the calender or transferring an accumulation of material to the calender surface in preference to bonding to the cooler cellulosic composite substrate opposite of the calender face. Combining this with the dissimilarity of surfaces between cellulosic materials and synthetic nonwoven material, this would be expected render such a process unworkable. The present invention is directed to a composite absorbent structure, and a method of forming it, which is achieved by calender bonding of an air laid absorbent core without added adhesive materials, and an associated nonwoven fabric layer.

### SUMMARY OF THE INVENTION

In accordance with the present invention, a composite absorbent structure is formed by air laying an absorbent core comprising cellulosic fibers, typically wood pulp fibers. The absorbent core may include superabsorbent polymeric material (SAP), for enhanced liquid absorption and retention.

The present invention contemplates that a nonwoven fabric layer be provided which comprises polymeric fibrous material, either in staple length or filamentary form. A composite material is formed in which the cellulosic fibers are hydrogen bonded to form an absorbent core and the nonwoven fabric layer is laminated to this hydrogen bonded layer, without adding additional non-cellulosic bonding agents (the cellulosic fibers themselves act as their own bonding agents) either to the cellulosic layer or between the cellulosic layer and the nonwoven. This material can be made using a calender bonding process. Calender bonding of the nonwoven fabric layer and the associated absorbent core is effected by the provision of cooperating calender rolls. It is preferred that calender bonding be effected in a manner which avoids significant adhesion of the nonwoven fabric layer to the calender rolls. It was unexpected to find process conditions for a relatively wide range of nonwoven technologies where effective bonding could be made to take place, yet adhesion and material build-up on the calender was avoidable. For some applications, it can be desirable to enclose the nonwoven fabric layer within plural air laid layers.

The nonwoven fabric layer which can be employed for practice of the present invention may be a resin bonded, staple length nonwoven fabric, but the present invention may also be practiced with the use of a through-air-bonded nonwoven fabric layer, which is typically thermally bonded by the provision of thermally-fusible, bi-component fibers in the fibrous matrix of the layer. Alternatively, a spunbonded or melt blown nonwoven can also be employed.

Other features and advantages of the present invention will become readily apparent from the following detailed description.

### BRIEF DESCRIPTION OF THE DRAWINGS

FIG. 1 is a diagrammatic view of an apparatus for practicing the present invention;

FIG. 2 is a sectional diagram of the material of the present invention, formed on tissue with a top layer of nonwoven;

FIG. 3 is a sectional diagram illustrating the structure of material of the present invention when formed on the nonwoven sheet, with a top layer of tissue added;

FIG. 4 is a sectional diagram illustrating the structure of the material of the present invention when formed on the nonwoven sheet and then an additional nonwoven sheet is bonded to the top surface; and

FIG. 5 is a sectional diagram illustrating the structure of the material of the present invention formed with top and bottom tissue layers, and an intermediate layer of nonwoven.

### DETAILED DESCRIPTION

While the present invention is susceptible of embodiment in various forms, there is shown in the drawing, and will hereinafter be described, a presently preferred embodiments, with the understanding that the present disclosure is to be considered as an exemplification of the invention, and is not intended to limit the invention to the specific embodiment illustrated.

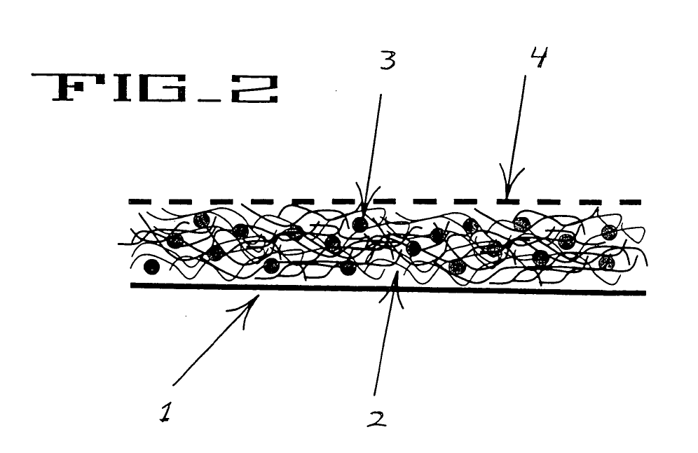

With reference to FIG. 2, a sheet of tissue (1) comprises the bottom layer. Cellulose (2) and optional superabsorbent polymer (3) comprise the next layer. These strata contain no non-cellulosic bonding materials. A nonwoven sheet (4) forms the upper surface of the composite, and is laminated with effective lamination strength to the layers below, without the use of additional bonding materials disposed between the nonwoven and the cellulosic fibers below.

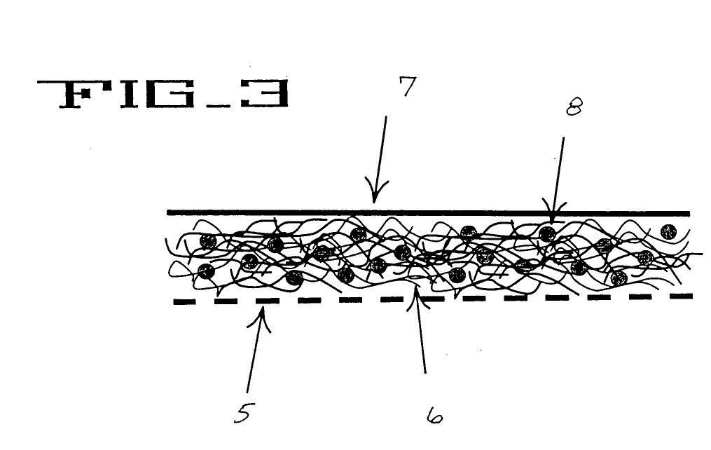

With reference to FIG. 3, a sheet of nonwoven (5) comprises the bottom layer of the composite structure. On top of this nonwoven sheet is a layer comprising cellulosic fibers (6) and optionally superabsorbent polymer (7), or superabsorbent fiber and containing no additional non-cellulosic bonding materials. On top of this is optionally a sheet of tissue (8).

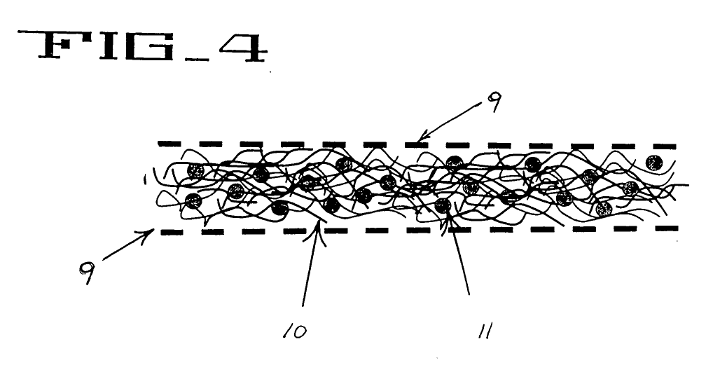

With reference to FIG. 4, a sheet of nonwoven (9) comprises the bottom layer of the composite structure. On top of this nonwoven sheet is a layer comprising cellulosic fibers (10), and optionally superabsorbent polymer (11). This layer contains no additional non cellulosic bonding materials. On top if this is a second sheet of nonwoven (9), with no additional bonding material disposed between the nonwoven and the cellulosic layer below.

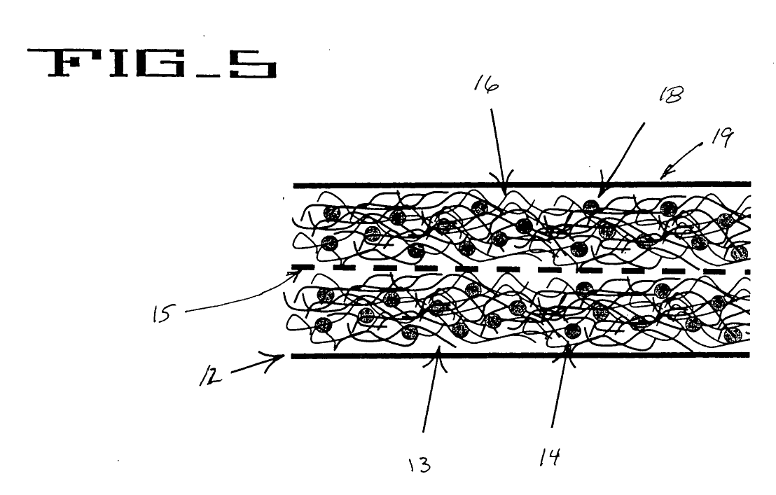

With reference to FIG. 5, a sheet of tissue (12) comprises the bottom layer of the composite structure. On top of this is a layer comprising cellulosic fibers (13), and optionally superabsorbent polymer granules (14). This layer contains no additional non-cellulosic bonding materials. On top of this is disposed a sheet of nonwoven (15). On top of this is a second layer comprising cellulosic fibers (16) and optionally superabsorbent polymer granules (18). This layer contains no additional non-cellulosic bonding materials. On top of this is disposed a sheet of tissue (19). The nonwoven sheet does not have any non-cellulosic bonding materials disposed between it and either the cellulosic layer above it or below it.

The cellulosic fibers can be any fluff pulp, such as RayFloc J-LD from Rayonier in located in Jesup, Ga. The tissue can be a 17 gsm tissue from Cellu tissue. A representative superabsorbent polymer is SXM 9200 from Stockhausen, located in Greensboro, N.C.

One parameter of the composite of the current invention is the lamination strength between the nonwoven and the cellulosic layers. The delamination test provides a measure of this bond strength. A meaningful delamination strength exceeds 0.5.N but more ideally exceeds 2N. In the most effective embodiments of the current invention, delamination strength exceeds 30N When the lamination strength between the nonwoven and the cellulosic layer exceeds a certain value, the internal strength of the cellulosic layers is exceeded and the failure plane in the test shifts from the nonwoven/cellulose bond to the weakest cellulose bond strata, usually somewhere near the middle depth within the cellulose portion of the composite where the heat from the bonding has penetrated the least.

Another parameter of the composite of the current invention is the tensile strength afforded by adding a layer of nonwoven to the surface. While typical hydrogen bonded airlaid materials have tensile strength around 15-20N and in extreme cases, using double layers of tissue, 35N/50 mm, the strength of the composite of the current invention can be easily made to exceed what can be measured using a 50N load cell in the tensile tester, by virtue of selecting a nonwoven substrate that has that tensile property. Since the wet strength of nonwovens is largely unaffected and the strength of hydrogen bonded airlaid composites is severely degraded in the presence of wetness, the introduction of a nonwoven substrate can increase the strength several-fold.

A third feature of the material of the current invention is the lamination strength to allow the tension on the sheet to reach a high value without delaminating due to the higher elongations of the nonwoven substrates. Again, using nonwovens with low elongations, it is possible to produce samples with single nonwoven layers that reach tensile values that exceed the ability of a 50N load cell to measure without having the cellulosic portion of the sheet peel away from the nonwoven.

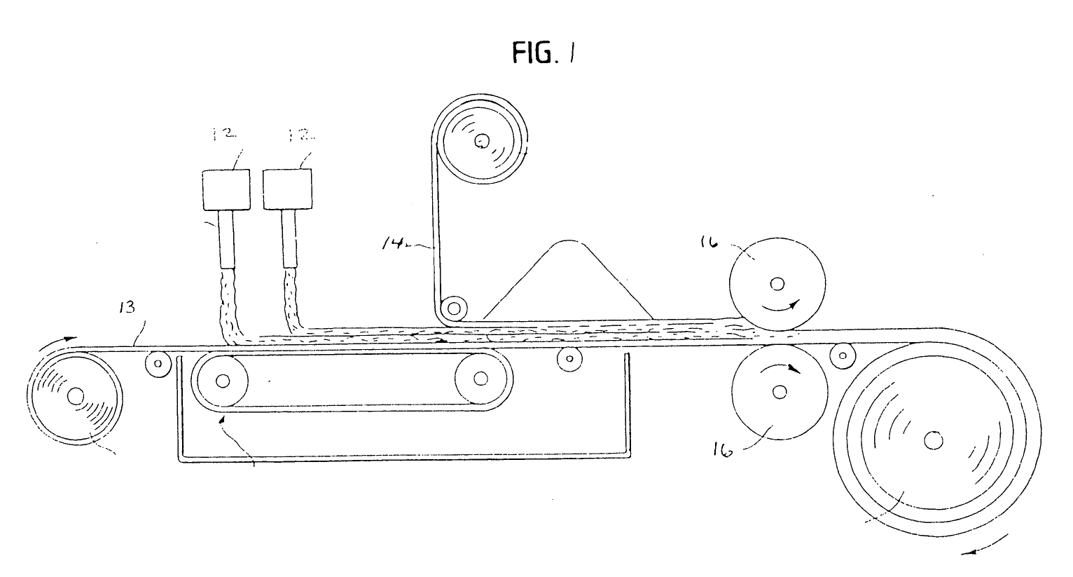

With reference to FIG. 1, therein is diagrammatically illustrated an apparatus for practice of the present method. The air laying and bonding apparatus illustrated in FIG. 1 includes an air laying station at which one or more dispensing heads 12 dispense cellulosic fibrous material, typically wood pulp, which may optionally include superabsorbent polymer. The air laid material is typically deposited on a carrier layer 13, typically a tissue layer. Alternatively, the tissue layer can be replaced with a nonwoven layer, which has the added advantage of providing a more air-permeable substrate, thus increasing air flow critical to the process. Formation of an air laid structure which can be used in practice of the present invention is more specifically disclosed in U.S. Pat. No. 5,866,242, No. 5,916,670, and No. 6,485,667, all hereby incorporated by reference.

In accordance with the present invention, a nonwoven fabric layer 14 is provided for bonding to the air laid absorbent core formed by the illustrated apparatus. The nonwoven fabric layer 14 comprises polymeric fibrous material, which may comprise either staple length fibers, or filamentary elements, such as formed by spunbonding, as is known in the art.

In accordance with the present invention, a nonwoven fabric layer 14 is integrated with the associated air laid absorbent core by the provision of a pair of cooperating calender rolls 16. Calender rolls 16 are preferably operated at a temperature no more than about the point where the polymeric fibrous material of nonwoven fabric layer 14 melts and adheres to the calender, as the layer 14 is brought into contact with one of the calender rolls. In this regard, the nonwoven fabric layer can be positioned between plural associated air laid layers by providing another air laid layer for positioning adjacent the fabric layer 14, opposite the first aid laid layer. Other layers may be positioned adjacent the fabric layer 14, opposite the first air laid layer. The calender rolls 16 simultaneously provide appropriate process conditions of heat and pressure to adequately hydrogen bond the cellulosic fibers.

While air laid cellulosic fibrous structures may typically be formed with an associated tissue carrier layer, to thereby lend strength and integrity to the structure, the present invention permits substitution of the nonwoven fabric layer for a tissue layer which might be otherwise employed in association with the cellulosic fibrous core. One benefit of this process variant is that nonwovens can be selected that have a much higher Frazier porosity than tissues typically used in the airlaid process and the additional air flow serves to greatly improve the air balance for the process.

Unexpectedly, the present method has been found to desirably affect adhesion and lamination of the nonwoven fabric layer to the associated cellulosic absorbent core without significant adhesion of the nonwoven fabric layer to the calender rolls 16. It has been presumed that the heat and pressure required to cause the synthetic materials in the nonwoven to bond to dissimilar cellulosic fibers would cause the synthetic material to adhere aggressively to the calender. This adhesion would result in materials being removed from the nonwoven surface as it separates from the calender resulting in damage to the nonwoven substrate and an increasing accumulation of materials on the surface of the calender. The most extreme case would be to cause the fibers to melt outright destroying the fibrous nature of the nonwoven sheet and coating the calender roll with melted polymer. This would potentially be an even greater tendency according to the presumption that material in direct contact with the face of the calender would reach a higher temperature than that on the opposite side of the sheet where the bonding is supposed to take place, increasing the chances that melting occurs transferring an accumulation of material onto the calender roll or causing sticking. In order have an effective process, it is necessary that the tension in the web after the calender is sufficient to separate the composite material of the present invention from the heated calender roll surface without tearing the web, and there is a requirement that the sheet separate without significant damage to the surface or transfer of fibers or other materials to the calender surface resulting in an increasing accumulation of build-up on the calender. Various nonwoven technologies behave differently in this regard and it is necessary to understand the relationship between temperature and the adhesion characteristics of the nonwoven, both to the heated calender surface and the cellulosic material of the present invention in order to set the proper process conditions.

When making a composite according to the present invention using a resin bonded nonwoven, it was found that at relatively low temperatures in the 120-130 C range, that the nonwoven adheres very aggressively to a heated steel surface, such as a calender roll and separation of the sheet is frequently destructive to the sheet. Unexpectedly, at higher temperatures, however, in the range from 140 C to 180 C, it was found that resin bonded nonwovens have a very low degree of adhesion to a calender roll and separate very easily with no damage to the sheet and no apparent accumulation of material on the calender surface. This temperature range, therefore, becomes the preferred calender temperature where the composite according to the present invention can be made using resin bonded nonwoven substrates.

When making a composite according to the present invention using a spunbonded polypropylene nonwoven technology, it is best to run the temperature of the calender near the melting point of the polypropylene fibers, which is around 160-170 C for typical polypropylene materials. Unexpectedly, it has been found that the polypropylene can be made to melt and bond to the cellulosic fibers while not melting and sticking to the surface of the calender, even when the side of the sheet facing the calender surface is presumably heated to a higher temperature than the side of the sheet facing the cellulosic fibers, which are cooler and contain moisture. Any nonwoven in contact with the calender while the machine is motionless, however quickly melts onto the surface of the calender and adheres aggressively.

When making a composite according to the present invention using a nonwoven containing bi-component fibers with a polyethylene sheath, it was found unexpectedly that even sheets containing 100% bi-component fibers will not stick to the calender at temperatures around 160 C, even though this far above the temperature where the polyethylene sheath in the bi-component fibers melts. The sheet separates easily from the calender surface and no accumulation of fibers or liquid polyethylene is observed on the surface of the heated calender while the process is running. When the machine is stopped, a layer of fluff fiber is observed adhering itself to a film of melted polyethylene on the surface of the calender. Nonwoven left in contact with the calender when the machine is stopped sticks aggressively to it.

In current practice of the present invention, nonwoven fabric layers have been provided which utilize resin bond, through-air bond, and spunbond technologies. Use of nonwoven fabric layers having basis weights from about 10 gsm to about 200 gsm is contemplated, with the resultant composite structure having a basis weight from about 50 gsm to as high as 600 gsm if the absorbent layer includes SAP.

Practice of the present invention can be conducted with the calender rolls 16 at a temperature in the range dependent on the type of nonwoven, as described earlier. Most of the examples were run in the range of 150 to 170 C. The upper end of the temperature range, as noted, should preferably no more than about the melt temperature of the specific nonwoven fabric fibrous material.

As will be appreciated, the specific nip pressure at which calender rolls 16 are operated will vary with the type of nonwoven fabric 14 being employed. With nip pressure varying from about 28 to about 400 Newtons per millimeter at transfer web width (160-2284 pounds force per inch of transverse web width). Line speed may be within the range of about 30 meters per minute up to 300 meters per minute, with about 200 meters per minute being typical for normal operation.

Significantly, a composite absorbent structure formed in accordance with the present invention effects a sufficient degree of bonding between the nonwoven fabric layer and associated air laid core as to resist delamination. If the layers are bonded sufficiently as to permit handling without delamination, is generally deemed that sufficient bonding has been effected. Delamination testing can be effected in accordance with standardized procedures. When tested in this fashion, a minimum delamination value of 0.2 Newtons is desired. A value of around 6 Newtons is preferred, and a value of 30 Newtons is possible to achieve.

Various types of calender surfaces can be used in accordance with the current invention. The calender can have a smooth surface, creating an uniform bonding, can be textured, such as with a linen pattern to enhance the bonding, or can be embossed with a land/sea pattern, such as a diamond patter or closely packed circles, creating intermittent bonding interspersed with low density regions.

Utilizing the discoveries associated with the current invention, it has proven possible to combine various technologies of synthetic nonwoven fabric layers with an associated absorbent cellulosic fibrous core, with bonding through use of calender bonding only, using existing calender bonding capital assets. This has allowed the incorporation of desirable features of the nonwoven fabric in the way of strength and integrity of the resulting composite for applications such as absorbent products, home care products, meat packaging products, and like disposable absorbent products.

### Test Procedures

In the tensile test procedure, a 240 mm×50 mm strip of material is cut using an appropriate size die and an Atom Model SE 20C die press from Associated Pacific Co. of Camarillo, Calif., or the equivalent. The strip is placed in a Zwick Model Z 005 tensile tester or the equivalent with a 50N load cell in the upper tensile portion of the machine between a pair of pneumatic gripping jaw fixtures. The jaws start at a distance of 200 mm apart. Prior to starting the test, the jaws move apart at 100 mm per minute to a 2N preload. Then the machine begins recording data and the jaws move apart at a rate of 100 mm/min until a 300 mm strain is reached, or the force becomes less than 95% of the maximum recorded value, whichever comes first. The machine stops recording data and the jaws return to a distance of 200 mm apart. The maximum force, in N is recorded along with the percent elongation and the work absorbed up until the break.

In the Delamination procedure, a strip of SpecTape ST 501, 48 mm width double-faced adhesive tape is sealed on the top of the material sample material. A 2-inch diameter sample is cut from the region entirely covered with tape using an appropriately sized die and an Atom Model SE 20C die press from Associated Pacific Co. of Camarillo, Calif. or the equivalent. The release paper is removed from the taped sample surface and it is attached to a 2-inch diameter upper platen fixture mounted to a 100N load cell in the lower compression portion of a Zwick Z005 tensile tester. A second piece of double-faced tape is placed on the flat lower compression platen is a position aligned so that when the upper platen with the attached sample is lowered until it is in contact with the lower platen, the entire samples touches taped surface. The release paper is removed from the tape on the lower platen thus exposing adhesive. The test starts with the platens 50 mm apart. The upper platen is lowered at a speed of 700 mm/min until the platens are 10 mm apart. The test begins and the top platen with the attached circular sample is lowered at a rate of 30 mm/min until the sample is pressed against the exposed adhesive face of the lower platen with a force of 35N, firmly attaching it to both the upper and lower platens. With both platens attached to the opposite faces of the sample with adhesive tape, the platens move apart at a rate of 75 mm/min until a separation of 10 mm is reached or the force drops below 80% of the maximum value. This step causes the sample to split into two layers, one remaining attached to the upper platen and one remaining attached to the lower platen. The test is completed and the platens then move apart to the original 50 mm separation so the sample can be removed. The maximum force involved in splitting the sample is recorded. Additionally, an observation is made whether the weak region in the sample where the split took place was at the lamination bond between the nonwoven and the cellulosic fibers, or if it is elsewhere in the structure.

The following examples demonstrate how nonwoven substrates of various technologies have been successfully integrated into calender bonded air laid sheets and the resulting sheet integrity properties that were imparted as a result.

### EXAMPLES

To assess the adhesion to a heated steel surface, handsheet samples of nonwoven were placed in a heated Carver lab press (Carver Model M, Fred S Carver Inc., Menominee Falls Wis.) and the oil pressure on the 4-inch bottle jack provided with the unit was pumped up to a pressure of 2000 psi, closing the heated platens on the nonwoven sample and applying pressure. The pressure was released after 30-seconds, allowing the platens to open and the nonwoven sample was removed from the press by pulling on an exposed tab of nonwoven extending beyond the edges of the platens.

A 12 gsm spunbond polypropylene nonwoven from PGI Nonwovens was tested at temperatures between 130 C and 170 C. No adhesion between nonwoven and steel was observed until a temperature of 165 C was reached. At 165 C a slight adhesion was noticed but this was easily peeled away leaving no residue. At 170 C, the sample shriveled up and melted onto the steel surface, requiring the melted residue to be scraped off of the platen surface.

22 gsm Resin Bonded PET nonwoven (6812 from PGI Nonwovens) was tested at temperatures ranging from 120 C to 180 C. At temperatures between 120 and 130 C, the sheet adhered aggressively to the steel, and the sheet was destroyed when an attempt was made to peel it off of the surface. A significant fraction of the sheet remained attached to the platen as a residue of fibers and resin and had to be scraped off. Unexpectedly, beginning at 140 C through 180 C, the adhesion between the sheet and he steel became very weak, and it was possible to peel the sheet off of the steel leaving no visible residue and no obvious damage to the sheet except a slight amount of observed flattening of the sample.

Utilizing the principles established by the previous investigation and applying it to a broad range of nonwoven technologies, the following examples of the current invention have been made:

To illustrate the integrity benefits of adding a nonwoven substrate to an absorbent composite, example 1 was made according to the prior art and serves as a comparison for Examples 2, 3, and 4.

### EXAMPLE 1

An absorbent composite material was made according to the prior art on a Dan Web airlaid commercially available from Dan Web Corporation in Aarhus, Denmark. The composite had a basis weight of 100 gsm, and comprised Cellulosic Fibers. The top and bottom of the composite had a layer of tissue.

The pulp was Rayfloc J-LD commercially available from Rayonier in Jesup, Ga. The tissue is a porous 17 gsm single-ply material available commercially as CTC grade 3008 from Cellu Tissue Corp in East Hartford, Conn. The machine was run at a web speed of 50 meters per minute. The bonding calender as run at an oil temperature of 160 C and a pressure sufficient to yield a density of 0.27 g/cc. The upper bonding calender roll was smooth and the lower roll had a linen texture.

The tensile and delamination strength are listed below in Table 1.

TABLE 1

| Example 1 Properties | Value | Units: |
|---|---|---|
| Tensile | 19.9 | N/50 mm |
| Delamination | 8.6 | N |

The next three examples illustrate the improvements in tensile strength that can be achieved by taking the above recipe and introducing various nonwoven substrates, according to the present invention.

### EXAMPLE 2

An absorbent composite material was made according to the present invention on a Dan Web airlaid machine commercially available from Dan Web Corporation in Aarhus, Denmark. The composite had a basis weight of 100 gsm, and comprised Cellulosic Fibers. The composite was formed on a layer of tissue. On top was a layer of resin bonded polyester nonwoven.

The pulp was Rayfloc J-LD commercially available from Rayonier in Jesup, Ga. The tissue was a porous 17 gsm single-ply material available commercially as CTC grade 3008 from Cellu Tissue Corp in East Hartford, Conn. The nonwoven was a 20.8 gsm resin bonded 6812 from PGI nonwovens in Rogers, Ark. The machine was run at a web speed of 50 meters per minute. The bonding calender as run at an oil temperature of 160 C and a pressure sufficient to yield a density of 0.27 g/cc. The upper bonding calender roll was smooth and the lower roll had a linen texture. During the run, no build-up of material on the calender was observed and the web was not observed to stick noticeably to the calender on the nonwoven side. The tensile and delamination results can be found in Table 2 below:

TABLE 2

| Example 2 Properties | Value | Units |
|---|---|---|
| Tensile | >50 | N/50 mm |
| Delamination | 7.0 | N |

The tensile strength was higher than the 50N load cell in the tensile tester could measure. Example 2 illustrates how the introduction of a nonwoven layer in place of tissue, according to the current invention, can improve the tensile strength of the sheet compared to Example 1, without the nonwoven layer. It also demonstrates how the current invention can enable a resin bonded polyester to be run as a drop-in replacement for a tissue layer in a calender bonded airlaid absorbent composite and exhibit good delamination values.

### EXAMPLE 3

An absorbent composite material was made according to the present invention on a Dan Web airlaid commercially available from Dan Web Corporation in Aarhus, Denmark. The composite had a basis weight of 100 gsm, and comprised Cellulosic Fibers. The composite was formed on a layer of resin bonded polyester nonwoven in place of the normal carrier tissue. On top was a layer of tissue.

The pulp was Rayfloc J-LD commercially available from Rayonier in Jesup, Ga. The tissue was a porous 17 gsm single-ply material available commercially as CTC grade 3008 from Cellu Tissue Corp in East Hartford, Conn. The nonwoven was a 20.8 gsm resin bonded 6812 from PGI nonwovens in Rogers, Ark. The machine was run at a web speed of 50 meters per minute. The bonding calender as run at an oil temperature of 160 C and a pressure sufficient to yield a density of 0.26 g/cc. The upper bonding calender roll was smooth and the lower roll had a linen texture. During the run, no build-up of material on the calender was observed and the web was not observed to stick noticeably to the calender on the nonwoven side. The tensile and delamination results can be found in Table 3 below:

TABLE 3

| Example 3 Properties | Value | Units: |
|---|---|---|
| Tensile | >50 | N/50 mm |
| Delamination | 8.6 | N |

Again, the tensile strength of the sample was too high for the 50N load cell in the tensile tester to measure. Example 3 illustrates how the introduction of a nonwoven layer in place of tissue, according to the current invention, can improve the tensile strength of the sheet compared to Example 1, without the nonwoven layer. It also demonstrates how the current invention can enable a resin bonded polyester nonwoven to be a drop-in replacement for the carrier tissue in an airlaid absorbent composite and exhibit good delamination values.

### EXAMPLE 4

An absorbent composite material was made according to the present invention on a Dan Web airlaid commercially available from Dan Web Corporation in Aarhus, Denmark. The composite had a basis weight of 100 gsm, and comprised Cellulosic Fibers. The layer of tissue on the top was replaced by a layer of through air bonded nonwoven consisting of 100% PE/PET bi-component fibers. The sheet was formed on a layer of tissue.

The pulp was Rayfloc J-LD commercially available from Rayonier in Jesup, Ga. The tissue was a porous 17 gsm single-ply material available commercially as CTC grade 3008 from Cellu Tissue Corp in East Hartford, Conn. The nonwoven was an 18 gsm thermally bonded nonwoven consisting of PE/PET Bi-component fibers commercially available as Article 1118WF0977 from Tenotex in Terno D. Isola in Italy. The machine was run at a web speed of 50 meters per minute. The bonding calender as run at an oil temperature of 160 C and a pressure sufficient to yield a density of 0.26 g/cc. The upper bonding calender roll was smooth and the lower roll had a linen texture. Even though the calender roll temperatures were above the melting temperature of the polyethylene sheathing on the bi-component fibers of the nonwoven, no build-up of material on the calender was observed and the web was not observed to stick noticeably to the calender on the nonwoven side. This result was very unexpected.

The resulting tensile and delamination strength is listed below in Table 4:

TABLE 4

| Example 4 Properties | Value | Units: |
|---|---|---|
| Tensile | 35.4 | N/50 mm |
| Delamination | 1.0 | N |

Example 4 illustrates how the introduction of a nonwoven layer in place of tissue, according to the current invention, can improve the tensile strength of the sheet compared to Example 1, without the nonwoven layer. It also demonstrates how the current invention can enable a thermally bonded bi-component fiber nonwoven to be a drop-in replacement for a tissue layer in an airlaid absorbent composite and exhibit useful delamination values.

### EXAMPLE 5

An absorbent composite material was made according to the present invention on a Dan Web airlaid machine commercially available from Dan Web Corporation in Aarhus, Denmark. The composite had a basis weight of 80 gsm, and comprised Cellulosic Fibers. The composite had a layer of spunbonded polypropylene nonwoven on both the upper and lower surfaces.

The pulp was Rayfloc J-LD commercially available from Rayonier in Jesup, Ga. The nonwoven was a 12 gsm spunbond polypropylene nonwoven commercially available from PGI nonwovens in Rogers, Ark. The machine was run at a web speed of 100 meters per minute. The bonding calender as run at an oil temperature of 155 C and a pressure sufficient to yield a density of 0.11 g/cc. The upper bonding calender roll was embossed with a diamond pattern and the lower roll had a linen texture. During the run, no build-up of material on the calender was observed and the web was not observed to stick to the calender while the machine was at run speed. The tensile and delamination results can be found in Table 5 below:

TABLE 5

| Example 5 Properties | Value | Units: |
|---|---|---|
| Tensile | >50 | N/50 mm |
| Delamination | 1.4 | N |

Example 5 illustrates how the introduction of nonwoven layers on top and bottom of an absorbent composite, according to the current invention, can improve the tensile strength of the sheet compared to Example 1, without the nonwoven layer. It also demonstrates how the current invention can enable a spunbonded polypropylene nonwoven material to be bonded on both faces of a cellulosic absorbent composite containing no non-cellulosic bonding material using a heated calender to a cellulosic composite yielding useful delamination strength while not sticking to the calender roll.

### EXAMPLE 6

An absorbent composite material was made according to the present invention on a Dan Web airlaid machine commercially available from Dan Web Corporation in Aarhus, Denmark. The composite comprised cellulosic fibers, superabsorbent polymer and nonwoven. The composite had a basis weight of 150 gsm, and contained 25% SAP. The composite had a layer of spunbonded polypropylene nonwoven on both the upper and lower surfaces.

The pulp was a blend of Rayfloc J-LD and Porosanier, commercially available from Rayonier in Jesup, Ga. The nonwoven was a 21 gsm spunbond polypropylene nonwoven commercially available as Sof Span 120 available from BBA nonwovens in Simpsonville N.C. The SAP was SA 65 S available commercially from Sumitomo Seika in Singapore. The machine was run at a web speed of 100 meters per minute. The bonding calender as run at an oil temperature of 155 C and a pressure sufficient to yield a density of 0.15 g/cc. The upper bonding calender roll was embossed with a diamond pattern and the lower roll had a linen texture. During the run, no build-up of material on the calender was observed and the web was not observed to stick to the calender while the machine was at run speed. The tensile and delamination results can be found in Table 6 below:

TABLE 6

| Example 6 Properties | Value | Units: |
|---|---|---|
| Tensile | 38.0 | N/50 mm |
| Delamination | 7.0 | N |

Example 6 demonstrates that the current invention allows the manufacture of an absorbent composite with nonwoven facing layers using spunbonded polypropylene technology while yielding useful delamination values, despite the dissimilarity of the cellulosic composite and the polypropylene nonwoven that is bonded to it and the requirement that the material not be heated past the melting point of the polypropylene fibers. It also demonstrates the improved tensile values that can be obtained by incorporating nonwoven materials into a calender bonded composite, when compared to example 1.

### EXAMPLE 7

An absorbent composite material was made according to the present invention on a Dan Web airlaid machine commercially available from Dan Web Corporation in Aarhus, Denmark. The composite comprised cellulosic fibers, and nonwoven. The composite had a basis weight of 270 gsm. The composite had a layer of resin bonded polyester nonwoven on both the upper and lower surfaces.

The pulp was a blend of Rayfloc J-LD and Porosanier commercially available from Rayonier in Jesup, Ga. The nonwoven was a 20.8 gsm resin bonded polyester nonwoven commercially available as 6812 from PGI nonwovens in Rogers, Ark. The machine was run at a web speed of 50 meters per minute. The bonding calender as run at an oil temperature of 160 C and a pressure sufficient to yield a density of 0.16 g/cc. The upper bonding calender roll was embossed with a diamond pattern and the lower roll had a linen texture. During the run, no build-up of material on the calender was observed and the web was not observed to stick noticeably to the calender. The tensile and delamination results can be found in Table 7 below:

TABLE 7

| Example 7 Properties | Value | Units: |
|---|---|---|
| Tensile | >50 | N/50 mm |
| Delamination | 27.3 | N |

Example 7 demonstrates how the current invention can be used to create absorbent composites using resin bonded polyester nonwovens that exhibit very high delamination strength as well as improved tensile. This was a very strong absorbent composite, relative to the other examples.

### EXAMPLE 8

An absorbent composite material was made according to the present invention on a Dan Web airlaid machine commercially available from Dan Web Corporation in Aarhus, Denmark. The composite comprised cellulosic fibers, superabsorbent polymer and nonwoven. The composite had a basis weight of 150 gsm and contained 25% SAP. The composite had a layer of resin bonded polyester nonwoven on both the upper and lower surfaces.

The pulp was a blend of Rayfloc J-LD and Porosanier, commercially available from Rayonier in Jesup, Ga. The nonwoven was a 20.8 gsm resin bonded polyester nonwoven commercially available as 6812 from PGI nonwovens in Rogers Ark. The SAP was SA 65 S commercially available from Sumitomo Seika in Singapore. The machine was run at a web speed of 75 meters per minute. The bonding calender as run at an oil temperature of 160 C and a pressure sufficient to yield a density of 0.14 g/cc. The upper bonding calender roll was embossed with a diamond pattern and the lower roll had a linen texture. During the run, no build-up of material on the calender was observed and the web was not observed to stick noticeably to the calender. The tensile and delamination results can be found in Table 8 below:

TABLE 8

| Example 8 Properties | Value | Units: |
|---|---|---|
| Tensile | >50 | N/50 mm |
| Delamination | 33.3 | N |

Example 8 demonstrates how the current invention can be used to create absorbent composites using resin bonded polyester nonwovens on both upper and lower faces of a composite containing SAP that exhibits very high delamination strength as well as improved tensile. This is also a very strong composite compared to the prior art and the other examples.

### EXAMPLE 9

An absorbent composite material was made according to the present invention on a Dan Web airlaid machine commercially available from Dan Web Corporation in Aarhus, Denmark. The composite comprised cellulosic fibers, superabsorbent fiber and nonwoven. The composite had a basis weight of 140 gsm and contained 20% Superabsorbent fiber (SAF). The composite had a layer of resin bonded polyester nonwoven on both the upper and lower surfaces.

Pulp A was Rayfloc J-LD commercially available from Rayonier in Jesup, Ga. Pulp B was Porosanier, also commercially available from Rayonier. The nonwoven was a 20.8 gsm resin bonded polyester nonwoven commercially available as 6812 from PGI nonwovens in Rogers Ark. The SAF was Oasis type 101 commercially available from Technical Absorbents located at Greater Coates, Grimsby, UK. The machine was run at a web speed of 75 meters per minute. The bonding calender as run at an oil temperature of 160 C and a pressure sufficient to yield a density of 0.15 g/cc. The upper bonding calender roll was embossed with a diamond pattern and the lower roll had a linen texture. During the run, no build-up of material on the calender was observed and the web was not observed to stick noticeably to the calender. The tensile and delamination results can be found in Table 9 below:

TABLE 9

| Example 9 Properties | Value | Units: |
|---|---|---|
| Tensile | >50 | N/50 mm |
| Delamination | 15.8 | N |

Example 9 demonstrates how the current invention can be used to create absorbent composites using resin bonded polyester nonwovens on both upper and lower faces of a composite containing Superabsorbent Fibers as well as cellulosic materials. The tensile strength is improved compared to Example 1 and the prior art.

### EXAMPLE 10

An absorbent composite material was made according to the present invention on a Dan Web airlaid machine commercially available from Dan Web Corporation in Aarhus, Denmark. The composite comprised cellulosic fibers and nonwoven. The composite had a basis weight of 80 gsm. The composite had a layer of spunbonded polypropylene nonwoven on both the upper and lower surfaces.

The pulp was a blend of Rayfloc J-LD and Porosanier commercially available from Rayonier in Jesup, Ga. The nonwoven was a 12 gsm spunbonded polypropylene nonwoven commercially available from PGI nonwovens in Rogers, Ark. The machine was run at a web speed of 75 meters per minute. The bonding calender as run at an oil temperature of 155 C and a pressure sufficient to yield a density of 0.11 g/cc. The upper bonding calender roll was embossed with a diamond pattern and the lower roll had a linen texture. During the run, no build-up of material on the calender was observed and the web was not observed to stick to the calender while the machine was at run speed. The tensile and delamination results can be found in Table 10 below:

TABLE 10

| Example 10 Properties | Value | Units: |
|---|---|---|
| Tensile | 26.6 | N/50 mm |
| Delamination | 1.5 | N |

Example 10 demonstrates how the current invention can be used to create absorbent composites using spunbonded polypropylene on both upper and lower faces of a composite containing both Porosanier pulp and J-LD pulp. This is done generating useful delamination strength using only the bonding calendars running at a temperatue below the melting temperature of the polypropylene.

### EXAMPLE 11

An absorbent composite material was made according to the present invention on a Dan Web airlaid machine commercially available from Dan Web Corporation in Aarhus, Denmark. The composite comprised cellulosic fibers, SAP, tissue, and nonwoven. The composite had a basis weight of 350 gsm. The composite had a layer of through-air bonded high-loft acquisition layer nonwoven on the upper surface, and tissue on the lower surface.

Pulp A was Rayfloc J-LD commercially available from Rayonier in Jesup, Ga. Pulp B was Porosanier, also commercially available from Rayonier. The acquisition layer nonwoven was a 30 gsm through air bonded high-loft PET nonwoven commercially available as Dri web T-9 from Libeltex in Meulebeke, Belgium. The tissue is a porous 17 gsm single-ply material available commercially as CTC grade 3008 from Cellu Tissue Corp in East Hartford, Conn. The machine was run at a web speed of 84 meters per minute. The bonding calender as run at an oil temperature of 160 C and a pressure sufficient to yield a density of 0.21 g/cc. The upper bonding calender roll was embossed with a diamond pattern and the lower roll had a linen texture. During the run, no build-up of material on the calender was observed and the web was not observed to stick noticeably to the calender. The tensile and delamination results can be found in Table 11 below:

TABLE 11

| Example 11 Properties | Value | Units: |
|---|---|---|
| Tensile | 21.4 | N/50 mm |
| Delamination | 5.6 | N |

Example 11 demonstrates how the current invention can be used to create absorbent composites using high-loft through air bonded acquisition layer creating a unitary absorbent core. This is done generating useful delamination strength using only the bonding calendar while maintaining the low density of the nonwoven acquisition layer.

### EXAMPLE 12

An absorbent composite material was made according to the present invention on a Dan Web airlaid machine commercially available from Dan Web Corporation in Aarhus, Denmark. The composite comprised cellulosic fibers, SAP, tissue, and nonwoven. The composite had a basis weight of 100 gsm. The composite had a layer of resin bonded polyester nonwoven on the upper surface, and low wet strength porous tissue on the lower surface.

The pulp was Rayfloc J-LD commercially available from Rayonier in Jesup, Ga. The SAP was SA 65 S commercially available from Sumitomo Seika located in Singapore. The nonwoven was a 20.8 gsm resin bonded polyester commercially available as 6812 from PGI nonwovens in Rogers, Ark. The tissue is a porous 17 gsm single-ply material available commercially as CTC grade 3008 from Cellu Tissue Corp in East Hartford, Conn. The machine was run at a web speed of 150 meters per minute. The bonding calender as run at an oil temperature of 160 C and a pressure sufficient to yield a density of 0.12 g/cc. The upper bonding calender roll was embossed with a diamond pattern and the lower roll had a linen texture. During the run, no build-up of material on the calender was observed and the web was not observed to stick noticeably to the calender. The tensile and delamination results can be found in Table 12 below:

TABLE 12

| Example 12 Properties | Value | Units: |
|---|---|---|
| Tensile | >50 | N/50 mm |
| Delamination | 1.8 | N |

From the foregoing, numerous modifications and variations can be effected without departing from the true spirit and scope of the novel concept of the present invention. It is to be understood that no limitation with respect to the specific embodiment disclosed herein is intended or should be inferred. The disclosure is intended to cover, by the appended claims, all such modifications as fall within the scope of the claims.

1. A method of forming a composite absorbent structure, comprising the steps of:
air-laying an absorbent core comprising cellulosic fibers;
providing a nonwoven fabric layer comprising polymeric fibrous material;
providing cooperating calender rolls; and
calender bonding said nonwoven fabric layer and said absorbent core.

2. A method of forming a composite absorbent structure in accordance with claim 1, wherein
one of said calender rolls defines an embossed pattern, said bonding step including contacting said nonwoven fabric layer with said calender roll defining said embossed pattern.

3. A method of forming a composite absorbent structure in accordance with claim 1, wherein
said nonwoven fabric layer comprises resin-bonded fibers.

4. A method of forming a composite absorbent structure in accordance with claim 1, including:
air-laying an additional layer, and positioning said additional layer adjacent said nonwoven fabric layer, opposite said absorbent core.

5. A method of forming a composite absorbent structure, comprising the steps of:
a. airlaying an absorbent core comprising cellulosic fibers without additional bonding materials in the airlaid portion;
b. providing a nonwoven fabric layer comprising polymeric fibrous material, without additional bonding material disposed between said nonwoven and said airlaid portion, and
c. providing cooperating heated calender rolls, and calender bonding said nonwoven fabric layer and said absorbent core, wherein the resulting bond had delamination strength exceeding 0.5N.

6. A method of forming a composite absorbent structure in accordance with claim 5 wherein:
said nonwoven fabric layer is selected from the group consisting of resin-bond nonwoven fabric, spunbond nonwoven fabric, and through-air bonded nonwoven fabric.

7. A method of forming a composite absorbent structure in accordance with claim 5, wherein:
one of said calender rolls defines an embossed pattern, said bonding step including contacting said nonwoven fabric layer with said calender roll defining said embossed pattern.

8. A composite absorbent structure formed in accordance with the method of claim 5.

9. A composite structure consisting of the following:
a. a stratum layer comprising cellulosic fibers containing no additional bonding materials; and
b. at least one nonwoven fabric layer comprising polymeric fibrous material, in which the two layers are bonded together without additional bonding materials between the stratum layer and the nonwoven fabric layer, and where the delamination strength exceeds 0.5 N.

10. A composite structure in accordance with claim 9, wherein:
said nonwoven fabric layer comprises a resin-bonded nonwoven fabric.

11. A composite structure in accordance with claim 9, wherein:
said stratum layer comprises superabsorbent polymer.

12. A composite structure in accordance with claim 9, wherein:
said nonwoven fabric layer comprises a spunbond fabric.

13. A composite structure in accordance with claim 9, including:
at least one tissue layer positioned adjacent said stratum layer.

14. A composite structure in accordance with claim 9, including:
a heat-bondable layer positioned adjacent said stratum layer.

15. A composite structure in accordance with claim 9, wherein:
said nonwoven fabric layer comprises a through-air bonded nonwoven fabric.
